(19) United States
(12) Patent Application Publication
(10) Pub. No.: US 2026/0307550 A1
(43) Pub. Date: Oct. 8, 2026

(54) RAIL SYSTEM FOR THE LONGITUDINAL ADJUSTMENT OF A VEHICLE SEAT

(71) Applicant: BROSE FAHRZEUGTEILE SE & CO. KOMMANDITGESELLSCHAFT, COBURG, Coburg (DE)

(72) Inventors: Sergej KOSTIN, Großheirath (DE); Waldemar SCHRÖDER, Ahorn (DE)

(21) Appl. No.: 19/485,165

(22) PCT Filed: May 16, 2024
(86) PCT No.: PCT/EP2024/063503

§ 371 Date: Nov. 17, 2025

(30) Foreign Application Priority Data
May 19, 2023 (DE) 10 2023 204 707.1

(51) Int. Cl. B60N 2/07

(52) U.S. Cl. CPC B60N 2/0722; B60N 2/0715

(57) ABSTRACT

A rail system for the longitudinal adjustment of a vehicle seat, comprising a first rail and a second rail which are mounted on one another for longitudinal sliding along a longitudinal direction, wherein an adjustment mechanism for the longitudinal adjustment is arranged between the two rails, and the first rail has a recess, in the region of which a transmission of the adjustment mechanism is arranged, the transmission being arranged between two retaining plates (24) which are offset to one another in the longitudinal direction and are fastened to the first rail. To increase stiffness and improve crash safety, at least one reinforcing plate extending in the transverse direction is fixedly connected to the first rail in the region of the recess at an open underside of the first rail.

The invention relates to a rail system for longitudinal adjustment of a vehicle seat.

The rail system regularly has two rails mounted on one another for longitudinal sliding, namely a top rail and a bottom rail, which are usually adjustable by means of an electric motor adjustment mechanism. This typically features a spindle drive, in which a spindle is adjusted via a (spindle) transmission. The transmission, typically a worm gear driven by a drive shaft which meshes with the external toothing of a spindle nut, is fastened to one of the two rails, for example the top rail. The rails are usually designed in the form of a U-rail with two side walls and a connecting transverse wall, which also defines an upper side in the case of the top rail. The rail typically has a recess, in the region of which the transmission is fastened between two retaining plates. A drive element, typically the drive shaft, passes through the recess.

The required recess weakens the rail, creating a weak point where there is a risk of failure in the event of a crash.

To increase the stiffness of the rails, for example in accordance with DE 10 2007 060 882B4 , the arrangement of a holding device is provided which is inserted into the recess. The holding device is designed in the form of a pre-bent housing with stiffening elements, which also includes the retaining plates.

According to US 2004/0206878A1 , the transmission is enclosed between the two longitudinally offset retaining plates and additionally between two lateral retaining elements, which protrude with a lug over the upper side of the rail. In this region, a curved retaining tab is attached, which accommodates the protruding lugs.

Based on this, the object of the invention aims to provide a rail system for longitudinal adjustment of a vehicle seat with high crash safety.

The problem is solved by a rail system for longitudinal adjustment of a vehicle seat with a first rail and a second rail which are mounted on one another for longitudinal sliding in a longitudinal direction. Each rail extends in the longitudinal, transverse, and vertical direction. These three directions are each perpendicular to one another. The first rail is designed in the form of a U-rail with two side walls and a connecting transverse wall, which also forms an upper side of the first rail. An adjustment mechanism for longitudinal adjustment is arranged in an interior space formed between the two rails. The first rail still has a recess, in the region of which a transmission of the adjustment mechanism is arranged. Two retaining plates, offset from one another in the longitudinal direction, are fastened to the first rail, and the transmission is arranged between them. The retaining plates are oriented perpendicular to the longitudinal direction and therefore extend in the transverse direction as well as in the vertical direction. To increase stiffness and improve crash safety, at least one reinforcing plate is firmly connected to the first rail on an underside opposite the upper side in the region of the recess. The reinforcing plate extends in a transverse direction and is fastened in particular to two opposing sub-portions of the first rail and thus at least indirectly to the two side walls.

By arranging the at least one reinforcing plate on the lower, open side of the U-shaped rail, the rail profile is virtually closed in the region of the recess, thus achieving an overall stiffening of the profile. At the same time, at least one reinforcing plate supports the holding function of the retaining plates through its positioning in the region of the recess.

The at least one reinforcing plate is, in particular, an additional component that is independent of the retaining plates, i.e., manufactured separately from them. The at least one reinforcing plate is preferably designed as a flat plate, which therefore extends only within a horizontal plane spanned by the longitudinal and transverse directions.

The first rail is in particular the top rail, and the second rail is the bottom rail. In the following, without limiting generality, the first rail will be referred to as the top rail and the second rail as the bottom rail. The bottom rail is fastened to a vehicle structure, such as the vehicle floor, in the mounted state, whereas the top rail is adjustable relative to the bottom rail and supports the vehicle seat.

In a preferred embodiment, the at least one reinforcing plate has two longitudinally spaced apart transverse struts that enclose the recess between them. The two transverse struts are arranged on both sides of the recess, so that they enclose it between them. If only a single reinforcing plate is provided, it will have the two opposing transverse struts. If several, in particular exactly two, reinforcing plates are provided, each reinforcing plate has exactly one transverse strut.

In a preferred embodiment, the transverse struts lie directly against the retaining plates. In particular, they are fastened to the retaining plates, for example by welding. This measure provides direct support for the holding function of the retaining plates through the transverse struts.

In an alternative embodiment variant, the transverse struts are spaced apart from the retaining plates.

The at least one reinforcing plate also has two longitudinal struts opposite one another in the transverse direction, with which it is fastened to the first rail, in particular to the aforementioned opposite sub-portions and via these at least indirectly to the side walls. The longitudinal struts, in addition to the transverse struts, increase the stiffness, in particular the torsional stiffness, of the at least one reinforcing plate.

In a preferred embodiment, the first rail has an angled edge tab on its underside at each side wall. The edge tabs form the previously mentioned opposing sub-portions of the first rail, to which at least one reinforcing plate is fastened. The side walls are therefore bent outwards in a transverse direction at their end oriented towards the underside, so that the edge tabs are formed. These form a fastening surface that extends parallel to the reinforcing plate. This ensures a flat surface for reliable fastening.

In accordance with a first embodiment variant, the reinforcing plate is preferably designed as a peripheral frame. This results in a high degree of stiffness.

Alternatively, exactly two reinforcing plates are arranged, which are spaced apart from one another in the longitudinal direction.

These are preferably U-shaped when viewed from above onto the underside, and each has a transverse strut and two opposing longitudinal struts angled at the ends of the transverse strut.

The fastening of the at least one reinforcing plate to the first rail is preferably done by welding.

Exemplary embodiments of the invention will be explained in more detail below with reference to the drawings. In the drawings:

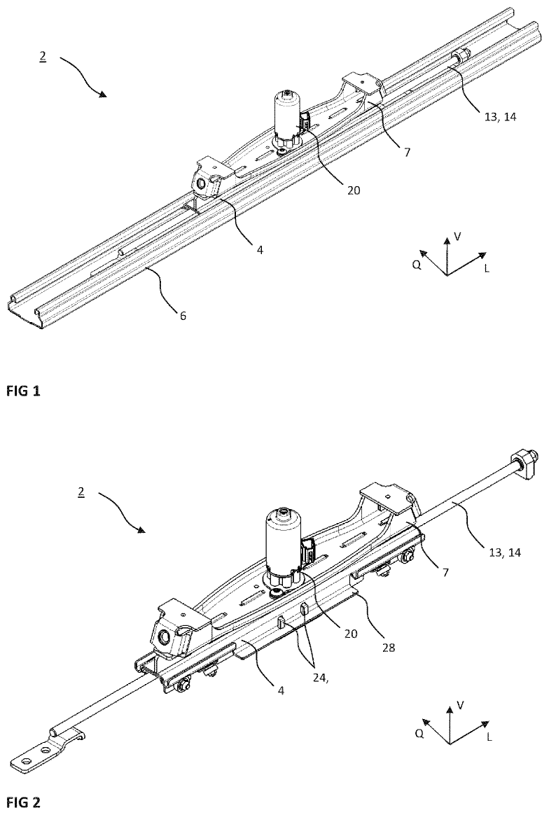

FIG. 1 shows a perspective view from above of a rail system with a top rail and a bottom rail,

FIG. 2 shows the rail system in accordance with FIG. 1 in perspective view, but without the bottom rail,

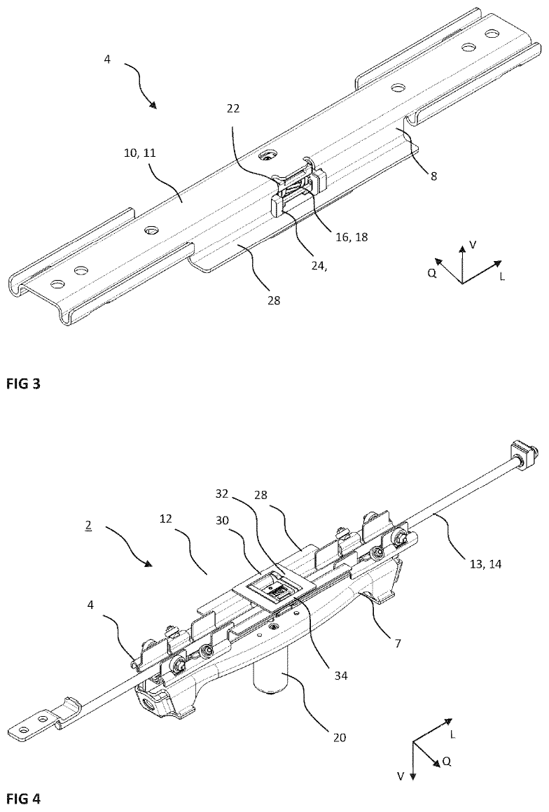

FIG. 3 shows a perspective view of an upper side of the top rail,

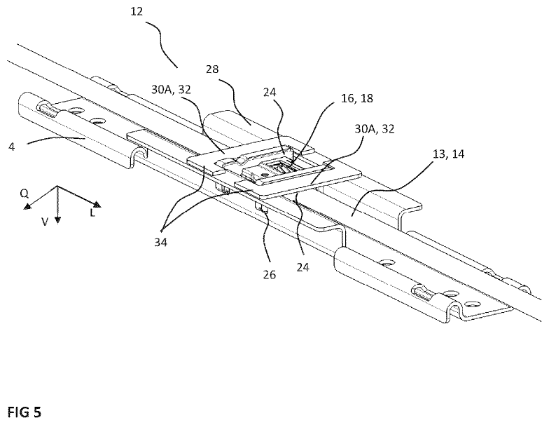

FIG. 4 shows the rail system in accordance with FIG. 2 in a perspective view from below onto the underside of the top rail with a reinforcing plate designed as a peripheral frame, and

FIG. 5 shows a perspective view of the underside of the top rail with two U-shaped reinforcing plates.

A rail system 2 shown in FIG. 1 serves for the longitudinal adjustment of a vehicle seat of a motor vehicle. It has a top rail 4 as the first rail and a bottom rail 6 as the second rail. The two rails 4, 6 are designed as profile rails and are mounted on one another for longitudinal sliding. The two rails 4, 6 generally extend in a longitudinal direction L, in a transverse direction Q and in a vertical direction V, each of which is oriented perpendicular to the other. In the exemplary embodiment, a fastening unit 7 is fastened to the top rail 4, via which, for example, the vehicle seat is fastened to the rail system 2.

The two rails 4, 6 are each designed in the form of a U-rail and each has two opposing side walls 8 and a transverse wall 10 connecting them (see in particular FIG. 3). The two profile rails 4, 6 are therefore open on one side. The transverse wall 10 forms an upper side 11 at the top rail 4. The opposite, open side of the U-profile defines an underside 12.

The two rails 4, 6 are oriented with their two open sides towards one another and at least parts of an adjustment mechanism 13 for longitudinal adjustment are arranged in the resulting interior space between the two rails 4, 6. The adjustment mechanism 13 is in particular a spindle drive with a spindle rod 14 which, in the exemplary embodiment, is firmly connected to the bottom rail 6. A spindle nut is arranged on the spindle rod 14, which has an external toothing 16 (see FIG. 3) into which a worm gear, not shown in detail here, meshes. This, together with the spindle nut, forms a (spindle) transmission 18, which is arranged in the interior space between the two rails (see in particular FIG. 3-5). In the exemplary embodiment, the transmission 18 is fastened to the top rail 4.

The aforementioned worm gear is driven by means of a typically electric-motor-driven drive element 20. In the exemplary embodiment, this is connected to the top rail 4, in particular to the fastening unit 7 fastened to the upper side 11 of the top rail 4. The drive element 20 carries a drive shaft, not shown in detail here, which is connected to the worm gear in order to set it into a rotary motion for an adjustment movement. The drive shaft is usually designed as a flexible shaft and is connected to an electric motor which is not shown in detail here.

For adjustment, the worm gear is driven and thereby sets the spindle nut in a rotary motion, so that it is adjusted along the stationary spindle rod 14 in the longitudinal direction L and with it the top rail 4.

To drive the worm gear or the spindle nut, a recess 22 in the top rail 4 is generally required, as can be seen in particular in FIG. 3. In the exemplary embodiment, said recess is preferably formed only in one of the two side walls 8. The recess 22 extends towards the transverse wall only as far as a (rounded) transition region between the side wall and the transverse wall. Otherwise, the transverse wall as well as the second side wall are not interrupted by the recess 22.

To fasten the transmission 18, in the exemplary embodiment there are arranged two retaining plates 24 opposite one another in the longitudinal direction L, between which the spindle nut is arranged. These retaining plates 24 each have opposite retaining lugs 26 in the transverse direction Q, which each pass through the corresponding side wall 8 and thereby form a form fit with it in or against the longitudinal direction L.

The retaining plates 24 generally have an opening, in particular designed as a through-hole, through which the spindle rod 14 passes. In the exemplary embodiment, the retaining plates 24 are designed as flat plates which extend within a vertical plane spanned by the vertical direction V and the transverse direction Q.

The top rail 4 has—preferably only in a sub-portion—edge tabs 28 bent outwards in a transverse direction from the side walls 8.

The retaining plates 24 protrude—viewed against the vertical direction V—beyond these edge tabs 28, preferably only slightly.

To increase crash safety and to reinforce the top rail 4, at least one reinforcing plate 30, 30A, 30B is provided.

In accordance with a first embodiment variant, as shown in FIG. 4, only a single reinforcing plate 30 is provided, which is designed as a peripheral closed frame. The frame is formed by two transverse struts 32 opposite one another in the longitudinal direction L and two longitudinal struts 34 opposite one another in the transverse direction Q.

In the second embodiment variant, as shown in FIG. 5, two reinforcing plates 30A, 30B are provided, each having a transverse strut 32 and two longitudinal struts 34 integrally molded onto its edge. Each reinforcing plate 30A, 30B is U-shaped when viewed from above onto the underside 12 of the top rail 4.

In both embodiment variants, at least one reinforcing plate 30, 30A, 30B with its longitudinal struts 34 lies flat on the edge tabs 28 and is firmly connected to them, in particular by welding.

The transverse struts 32 are arranged opposite one another, in particular such that the recess 22 and the retaining plates 24 are positioned between them.

In the exemplary embodiment shown in FIG. 4 and FIG. 5, the retaining plates 24 lie directly against the transverse struts 32. The transverse struts 32 therefore form a support for the retaining plates 24, preferably on the side of the retaining plates 24 opposite the recess 22. In the mounted position, the retaining plates 24 protrude slightly beyond or are flush with at least one reinforcing plate 30, 30A, 30B in the opposite direction to the vertical direction V. In the exemplary embodiment, the corresponding retaining plate 24 protrudes only by means of a chamfer formed on its edge over the at least one reinforcing plate 30, 30A, 30B.

The at least one reinforcing plate 30, 30A, 30B is designed as a flat plate which extends only within a transverse plane (horizontal plane) which is spanned by the transverse direction Q and the longitudinal direction L.

By arranging the at least one reinforcing plate 30, 30A, 30B, the profile of the top rail 4 is virtually closed on its underside 12, thus achieving a significant reinforcement. At the same time, by enclosing the retaining plates 24 with at least one reinforcing plate 30, 30A, 30B, a significantly improved force transmission in the event of a crash is achieved in the top rail 4, specifically in the regions outside the recess 22. This allows the weak point of the top rail 4 formed by the recess 22 to be bridged by force.

Another advantage can be seen in the particularly simple embodiment of the at least one reinforcing plate 30, 30A, 30B as a merely flat sheet, which is designed, for example, as a stamped part. The connection to the top rail 4 is preferably made by welding, so that the overall mounting process is very easy.

### LIST OF REFERENCE SIGNS

2 Rail system
4 Top rail
6 Bottom rail
7 Fastening unit
8 Side wall
10 Transverse wall
11 Upper side
12 Underside
13 Adjustment mechanism
14 Spindle rod
16 External toothing
18 Transmission
20 Drive element
22 Recess
24 Retaining plate
26 Retaining lugs
28 Edge tab
30 Reinforcing plate
30A, 30B Reinforcing plate
32 Transverse strut
34 Longitudinal strut
L Longitudinal direction
V Vertical direction
Q Transverse direction

1. A rail system for the longitudinal adjustment of a vehicle seat, comprising a first rail and a second rail which are mounted on one another for longitudinal sliding along a longitudinal direction wherein each rail extends in the longitudinal direction, in the transverse direction and in the vertical direction (V), and the first rail is designed in the manner of a U-rail with two side walls and a transverse wall connecting them, and the transverse wall forms an upper side of the first rail, wherein an adjustment mechanism for the longitudinal adjustment is arranged between the two rails, and the first rail has a recess, in the region of which a transmission of the adjustment mechanism is arranged, the transmission being arranged between two retaining plates which are offset to one another in the longitudinal direction and are fastened to the first rail, which extend in the transverse direction and in the vertical direction, wherein at least one reinforcing plate extending in the transverse direction is firmly connected to the first rail on an underside opposite the upper side in the region of the recess.

2. The rail system according to claim 1, wherein the at least one reinforcing plate has two transverse struts spaced apart from one another in the longitudinal direction, which are arranged on both sides of the recess in the longitudinal direction.

3. The rail system according to claim 2, wherein the transverse struts rest against the retaining plates.

4. The rail system according to claim 2, wherein the transverse struts are spaced apart from the retaining plates.

5. The rail system according to claim 1, wherein the at least one reinforcing plate has two longitudinal struts opposite one another in the transverse direction, with which it is fastened to the first rail.

6. The rail system according to claim 1, wherein the first rail has an angled edge tab on its underside on the corresponding side wall, and the at least one reinforcing plate is fastened to the opposite edge tabs (28).

7. The rail system according to claim 1, wherein the reinforcing plate (30) is designed as a peripheral frame.

8. The rail system according to claim 1, wherein two reinforcing plates are arranged which are spaced apart from one another in the longitudinal direction.

9. The rail system according to claim 8, wherein the two reinforcing plates—when viewed from above onto the underside—are U-shaped, each with a transverse strut and with two longitudinal struts extending in the longitudinal direction.

10. The rail system according to claim 1, wherein the at least one reinforcing plate is welded to the first rail.

11. The rail system according to claim 2, wherein the at least one reinforcing plate has two longitudinal struts opposite one another in the transverse direction, with which it is fastened to the first rail.

12. The rail system according to claim 3, wherein the at least one reinforcing plate has two longitudinal struts opposite one another in the transverse direction, with which it is fastened to the first rail.

13. The rail system according to claim 4, wherein the at least one reinforcing plate has two longitudinal struts opposite one another in the transverse direction, with which it is fastened to the first rail.

14. The rail system according to claim 2, wherein the first rail has an angled edge tab on its underside on the corresponding side wall, and the at least one reinforcing plate is fastened to the opposite edge tabs.

15. The rail system according to claim 3, wherein the first rail has an angled edge tab on its underside on the corresponding side wall, and the at least one reinforcing plate is fastened to the opposite edge tabs.

16. The rail system according to claim 4, wherein the first rail has an angled edge tab on its underside on the corresponding side wall, and the at least one reinforcing plate is fastened to the opposite edge tabs.

17. The rail system according to claim 5, wherein the first rail has an angled edge tab on its underside on the corresponding side wall, and the at least one reinforcing plate is fastened to the opposite edge tabs.

18. The rail system according to claim 2, wherein two reinforcing plates are arranged which are spaced apart from one another in the longitudinal direction.

19. The rail system according to claim 3, wherein two reinforcing plates are arranged which are spaced apart from one another in the longitudinal direction.

20. The rail system according to claim 4, wherein two reinforcing plates are arranged which are spaced apart from one another in the longitudinal direction.
